(19) United States
(12) Patent Application Publication
(10) Pub. No.: US 2012/0051365 A1
(43) Pub. Date: Mar. 1, 2012

(54) Beacon For A Star Network, Sensor Nodes In A Star Network, Method For Initializing A Gateway In A Star Network And Method For Operating A Star Network

(75) Inventors: Michael Bahr, Munchen (DE); Norbert Vicari, Munchen (DE)

(73) Assignee: SIEMENS AKTIENGESELLSCHAFT, MUENCHEN (DE)

(21) Appl. No.: 13/319,253

(22) PCT Filed: May 7, 2010
(86) PCT No.: PCT/EP10/56248

§ 371 Date: Nov. 7, 2011

(30) Foreign Application Priority Data
May 7, 2009 (DE) 10-2009-020-206.4
Oct. 5, 2009 (DE) 10-2009-048.303.9

(51) Int. Cl. H04L 12/56

(52) U.S. Cl. 370/401

(57) ABSTRACT

A beacon for a star network comprising a gateway and at least one sensor node, where the beacon includes fields containing information on the length of a base time-slot and information on the number of used base time-slots per management time-slot, where the management time-slots are used at least to transmit configurations for the star network. In addition, the sensor node in the star network includes a data structure for saving a star network configuration, and the data structure includes a configuration gateway ID and a configuration sequence number as attributes.

### CROSS-REFERENCE TO RELATED APPLICATIONS

This is a U.S. national stage of application No. PCT/EP2010/056248 filed 7 May 2010. Priority is claimed on German Application No. 10 2009 020 206.4 filed 7 May 2009 and German Application No. 10 2009 048 303.9 filed 5 Oct. 2009, the contents of which are incorporated herein by reference in their entirety.

### BACKGROUND OF THE INVENTION

1. Field of the Invention

The invention relates to communication networks and, more particularly, to a beacon for a star network, a sensor node in the star network, a method for initializing a gateway in the star network and a method for operating the star network.

2. Description of the Related Art

Production automation has very high quality requirements for wireless networks, in particular a very small guaranteed response time (node would like to send a datum, where datum is received by the recipient). Attempts are usually made to achieve this with a star-shaped network using a timeslot method, such as Time Division Multiple Access (TDMA). The central node of the network, i.e., the gateway, stipulates a superframe that contains the allocation of the timeslots to the individual sensor nodes. The necessary synchronization of the sensor nodes with the superframe is effected by periodically emitting beacons by the gateway as the start of each superframe. In order to meet the high time demands, as much status information as possible is stored implicitly so that the data packets are very small (see also M. Bahr, M. Vicari, L. Winkel: Proposal for Factory Automation, IEEE P802.15 Wireless Local Area Networks, document 15-09/0228r0, March 2009—hereinafter referred to as document, in which the smallest MAC packet is just 4 bytes in size for a byte of payload).

Such optimization, however, is achieved at the cost of flexibility. For a single fixed wireless star network in which the nodes always listen for the gateway beacons, i.e., are always on, and also never leave this network, i.e., no roaming of the sensor nodes occurs between various gateways, this works quite well.

However, there are also numerous application cases where these restrictions do not apply and somewhat greater flexibility is required. Firstly, to save energy, some sensor nodes switch themselves off and by doing so miss multiple beacons. Secondly, sensor nodes move through the radio areas of multiple star networks/gateways (roaming), for example, on a conveyor belt.

Using the current mechanisms as described in document referred to above, there are no self-organizing methods for this which can cope efficiently with it. Once a sensor node has not noticed a certain number of beacons or has switched to the area of a different gateway, severe disruptions in wireless data transmission can occur:
Missed beacons: the sensor node has possibly “slept through” a new configuration of the superframe. Since the configuration is stored implicitly though, it cannot recognize it from the beacons. If it now transmits using the configuration which it knows but which is obsolete, then data collisions may occur.
Roaming: the sensor node does not know which star network it is currently located in. While conflicts in data communication can be avoided here using an external configuration, they often leave resources unused as in this case the entire roaming route has to be taken into account in the planning of the superframe assignments. Only taking account of the star networks locally would enable better utilization of the resources here.

Added to this is the fact that in the Institute of Electrical and Electronic Engineers (IEEE) 802.15.4-2006 standard (IEEE 802: Part 15.4: Wireless Medium Access Control (MAC) and Physical Layer (PHY) Specifications for Low-Rate Wireless Personal Area Networks (WPANs), IEEE Std 802.15.4™-2006, September 2006—hereinafter referred to as document), which forms the basis for document [1] referred to hereinabove and for this invention, the interframe spacing (IFS), i.e., the minimum interval between two packets is very greatly increased in the case of MAC packets which are greater than 18 bytes: From 12 symbols (corresponding to 6 bytes) to 40 symbols (corresponding to 20 bytes). This is an enormous time loss that should if possible be avoided, i.e., the beacon should as a rule be ≦18 bytes on the MAC layer.

Star networks are a popular topology for wireless networks. There is always a central node (access point, coordinator, base station, gateway, etc.) with which the terminal devices (stations, clients, terminal devices, sensor nodes, etc.) communicate directly.

IEEE 802: Part 11: Wireless LAN Medium Access Control (MAC) and Physical Layer (PHY) Specifications, IEEE Std 802.11™-2007, September 2007—hereinafter referred to as document [3]), defines a beacon for the access points so that WLAN stations can recognize these and can associate themselves with them. The structure of an IEEE 802.11 beacon is shown in FIG. 1. The main purpose of the beacons in IEEE 802.11 is that the WLAN stations can recognize access points and associate themselves with them. The access point can also take on coordination functions (point coordinator function). This is not, however, a timeslot method. Instead, the devices are explicitly queried by the access point (point coordinator).

The individual fields of the structure shown in FIG. 1 of an IEEE 802.11 beacon have the following meanings (only those relevant to the invention are listed here):
SA: stands for source address and contains the MAC address of the access point.
BSSID: stands for basic service set identifier and identifies the star network. The MAC address of the access point is used as the BSSID.
Sequence control: is used for defragmenting and for detecting packets transmitted more than once. The field consists of 4 bits for the fragment number and 12 bits for the sequence number, by means of which the various packets can be differentiated.

IEEE 802.11 is based on the CSMA (carrier sense multiple access) method so that new devices also have an opportunity to transmit data. Even if the PCF is used, there is always a CSMA-based contention period.

Document [2] defines a “beacon-enabled” mode in which a superframe structure is defined which also provides timeslots (see FIG. 2). Up to seven “guaranteed timeslots (GTS)” can be defined by the coordinator for each superframe.

The beacon is periodically emitted by the coordinator and is used for synchronizing the devices associated with the coordinator, identifying the star network and describing the structure of the superframe. FIG. 3 shows the structure of the beacon.

The individual fields of the beacon shown in FIG. 3 have the following meanings (only those relevant to the invention are listed):
Sequence number: is the beacon sequence number which is increased by 1 with each beacon emitted.
Addressing fields: contain the
   PAN-ID of the source (2 bytes). The PAN-ID identifies the personal area network. This may be a single star network or even a network consisting of multiple star networks.
   Source address (2 or 8 bytes corresponding to the address format used).
Frame control: consists itself of multiple sub-fields which are shown in FIG. 4. The individual sub-fields have the following meanings:
   Frame type: indicates the type of the packet, i.e., whether it is a beacon.
   PAN-ID compression: avoids, if set, the source PAN-ID field, if source and destination lie in the same PAN. Source and destination address must be contained in the packet.
   Destination addressing mode: specifies which address format is used for the destination address. This parameter is not needed in the case of beacons.
   Frame version: helps with the recognition of frames which are not compatible with the previous version IEEE 802.15.4-2003 of the standard. Mechanism for backwards compatibility.
   Source addressing mode: specifies which address format is used for the source address. In the beacon, this can be either the short address format (2 bytes) or the full address format (8 bytes).

In the contention access period in which access is regulated via CSMA, new devices can log on and apply for appropriate GTS. The length of the contention access period derives from the superframe specification transmitted in the beacon.

In document [1] mentioned in the introduction a star network with a timeslot method is defined, by means of which a very small delay is possible. A key feature is a very short MAC header (1 byte). The superframe is configured in explicit configuration modes, during normal operating mode this information is available in the nodes only implicitly. The central node is called a gateway, the devices connected in a star-shape are termed sensors or actuators.

The beacon contains very little information and actually serves only to indicate the mode and to synchronize the sensors with the superframe. FIG. 5 shows the structure of the beacon.

The individual fields of the beacon have the following meanings:
Shortened frame control: is the MAC header shortened to 1 byte and contains the following fields (see FIG. 6):
   Frame type: specifies a class of special packet types that use the short MAC header
   Sub frame type: specifies the packet type within the class of packets with a short MAC header, for example the packet type beacon.
Flags/Beacon payload: contains the beacon's control information, including also the mode. Since the invention is intended for online mode (normal operating mode), only the beacon payload provided for this is considered here. This is shown in FIG. 7 and contains the following fields:
   Transmission mode: indicates the transmission mode (configuration modes or normal operating mode)
   Actuator direction: indicates the send direction for actuators (downlink/uplink)
   Group acknowledgement: is a bit field that contains acknowledgements for the individual (uplink) timeslots.
FCS: is the frame control sequence and serves in reviewing the error-free transmission of a packet.

New devices cannot actually log on or send control packets to the gateway in normal operating mode. During the configuration modes it can be stipulated that management timeslots in which CSMA access applies are present at the start of the superframe. However, this configuration is not known to the new devices. As a result, they cannot use these management timeslots. The same is true of shared-group timeslots, in which CSMA access is also possible, but the configuration of the shared-group timeslots is not known to the new devices.

### SUMMARY OF THE INVENTION

It is therefore an object of the invention to upgrade a beacon such that upon receipt of the beacon configurations of the star network can be differentiated, gateways can be differentiated, and new sensors or human-machine-interface (HMI) devices have the possibility of sending control packets to the gateway.

This and other objects and advantages are achieved in accordance with the invention that provides an upgraded beacon comprising configuration of the management timeslots, i.e., length of a base timeslot, and
number of base timeslots used per management timeslot, a Gateway ID, and a configuration sequence number (CSN) for the actual configuration

### Configuration of Management Timeslots

Management timeslots are used in a superframe for transmitting configurations for the system. The management timeslots are always planned in pairs, where one management timeslot is available for each transmission direction (uplink/downlink). The management timeslots are arranged directly after the beacon. Access to the management timeslots is always performed based on the CSMA method. Depending on the application, the size of a configuration message may exceed the size of a base timeslot. It is therefore, where appropriate, necessary for the management timeslots to be longer than a base timeslot. Such a management timeslot is specified by the two parameters “Timeslot size” and “Number of base timeslots per management timeslot”

### Gateway ID

The gateway ID is an identifier for the gateway of a star network. It may be derived from the MAC address of the gateway, but does not have to be. The Gateway ID may, for example, be a random number, or be predefined by a network management system.

The gateway ID is also stored as an attribute of a star network configuration in the relevant sensor nodes. If a sensor node moves between multiple gateways, then it can select the appropriate configuration using the gateway ID transmitted in the beacon.

Without the gateway ID, the exact pathway, i.e., the exact order of star networks passed through, would have to be specified when roaming in order for appropriate configurations to be reloaded. If the sensor node moves along the wrong path and comes to a star network out of turn, there is the risk of data collisions and serious disruptions in data communication.

With the gateway ID, the sensor node can select the right configuration for the current gateway and as a result can move much more flexibly when roaming.

### Configuration Sequence Number (CSN) for Current Configuration

The above remarks on the gateway ID still assume that the current configuration in a defined star network does not change. With the configuration sequence number, a change in the configuration of a star network can also be recognized.

The configuration sequence number is primarily an identifier for a defined configuration of the star network. If the CSN from the beacon does not match the CSN stored as an attribute of the star network configuration in the sensor node, it can be assumed that the sensor node does not know the current configuration. In order to avoid data collisions and serious disruption to data communication in the star network, the sensor node must not then transmit according to its configuration but must wait until the next configuration cycle or obtain the current configuration of the gateway.

The design of the CSN as a sequence number makes it possible for the value range to be exploited to the maximum for different configurations. Each new configuration cycle of the star network increases the CSN on the gateway by 1. In this way, certain chronological interrelations of the configurations can also be derived if needed.

This new information can be positioned very variably in terms of size and sequence in the beacon without the functionality being changed. A favored structure of the beacon in accordance with the invention is depicted in FIG. 8. Other structures are also possible.

The individual fields of the beacon in accordance with the invention shown in FIG. 8 have the following meanings:
Shortened frame control: the shortened frame control field corresponds to the frame control field from document [1] or an equivalent frame control field.
Flags: The flags field contains various control bits:
   Transmission mode: differentiates between the transmission modes, in particular between discovery mode, configuration mode and normal operating mode.
   Actuator direction: this field is of significance only in normal operating mode and indicates the direction of communication of the actuators (downlink/uplink) and is already contained in document [1].
   Number of base timeslots per management timeslot: indicates the number of base timeslots for a management timeslot. The range of values goes from 0 (no management timeslots present) to 7 (maximum length of management timeslots). Downlink- and uplink-management timeslots are of equal length.
Gateway ID: is the freely selectable identifier of the gateway. With a gateway ID of 1 octet up to 256 different gateways, and thus star networks can be differentiated.
Configuration sequence number: the configuration sequence number (CSN) of 1 octet allows 256 uniquely differentiable configurations. Since a configuration change tends to occur rarely, this number is adequate.
Timeslot size: the size of a base timeslot tss in multiples of octets. Other units are conceivable. In addition, the offset is also important. The higher the offset, the longer the base timeslots can be. Calculation of the time duration changes, however.
   The general rule for calculating the duration of a base timeslot is as described in document [2] for the 2.4 GHz bit transmission layer (PHY):
   t_{TS}: =((p+(m+n))·2 symbol/octet+12 or 40 symbol {m+n≦18 octet or m+n>18 octet})/V_{symbol}, where p is the number of octets of the PHY header (6 octets), m is the number of octets of the MAC overhead (3 octets), n is the number of octets of payload data and V_{symbol} is the symbol speed of 62500 symbol/s.
   If the offset o=0, then the specific number of bytes of the timeslot stands here in tss.
   t_{TS}: =(tss ·2+12 or 40 {tss−6≦18 or tss−6>18 })/62500, max: =8,800 ms
   If the offset o=6, then the number of bytes of the MAC packet, i.e., excluding the bytes of the PHY header, stands here in tss
   t_{TS}: =((tss+6)·2+12 or 40 {tss≦18 or tss>18 })/62500, max: =8,992 ms
   If the offset o=9, then the number of bytes of payload data, i.e., excluding the bytes of the packet header, stands here in tss
   t_{TS}: =((tss+9)·2+12 or 40 {tss+3≦18 or tss+3>18})/62500, max: =9,088 ms

The variant with an offset that corresponds to the total overhead of a packet (here 9) yields the greatest number of possible base timeslots, as well as the longest. In order to be able to decide more effectively on the length of the interframe spacing (12 or 40 symbols), the comparison should be executed somewhat differently: tss≦18-3, i.e. tss≦15.

The preferred variant is a calculation using the length of the MAC packet (middle variant), as this calculation can also be applied to different variants of the PHY layer and simplifies the calculation of the interframe spacing to be used.
Group acknowledgements: is used only in normal operating mode to provide feedback on the receipt of data from the sensor nodes.
FCS: is the frame control sequence and serves to recognize bit transmission errors.

### Extensions in Sensor Nodes

The data structure in the sensor node for storing the configuration must be extended by two attributes: gateway ID and configuration sequence number (CSN). In addition, it is advantageous if the data structure is organized as a list or a field that can store k≧1 configurations (see FIG. 9). Without the facility for storing multiple gateways simultaneously in the sensor node, flexible roaming cannot be supported.

Rules for Using the Invention

When the gateway is initialized, a value for the gateway ID and the start value of the configuration sequence number (CSN) must also be defined.
For the gateway ID, a random number can be used, for example, or else the final octet of the MAC address. These methods are particularly suitable if only one star network is used. If multiple star networks are to be used so that roaming of the sensor nodes between various gateways is possible, there is a small probability that with these methods the same gateway IDs will be assigned for different gateways. In this case, it is recommended that the gateway IDs be set manually or by a network management system with which unique gateway IDs can be fixed. It is also conceivable to use a distributed algorithm for recognizing duplicates in the gateway ID or for assigning duplicate-free gateway IDs that exchanges relevant data over the backbone that connects all the gateways to one another.
For the CSN, a random start value is normally used. If the CSN reaches the maximum value, here 255, then the next value is 0 (sequence number rollover). Relevant mechanisms are known which recognize the relevant relation 255<0.

In a star network as defined in document [1], there are three transmission modes which stand for various stages of configuration and operation (see FIG. 10), and which are fixed by the gateway and communicated in the beacon.

Discovery mode serves to “discover” all the sensor nodes in range of the gateway. The superframe consists only of beacon and the two management timeslots (downlink/uplink). It is therefore important that the inventive extension of the beacon for configuring the management timeslots is contained in the beacon so that the (new) sensor nodes can correctly compete for access to the transmission medium. In discovery mode, the configuration sequence number does not need to be contained in the beacon and/or does not need to be evaluated.

In configuration mode, the gateway transmits to all the sensor modes discovered in discovery mode the configuration valid for them. The superframe consists only of beacon and the two management timeslots (downlink/uplink). It is therefore important that the inventive extension of the beacon for configuring the management timeslots is contained in the beacon so that the (new) sensor nodes can correctly compete for access to the transmission medium. In this mode, the configuration sequence number must be contained in the beacon. It identifies the configuration of the star network which is currently being communicated to the sensor node. For each new configuration, the configuration sequence number has to be increased by 1. A new configuration is often found, but not necessarily when a switch is made to configuration mode. Since a change of the CSN means that all the sensor nodes have to receive a new configuration before they can take part in communication in the star network again, the CSN should be increased only when there is a quantitatively different configuration leading to conflicts with the existing configuration. If an available timeslot which, however, it is guaranteed, is not being used under the old configuration, is assigned in the new configuration to a sensor node, the CSN does not need to be increased as no conflicts in the data transmissions can occur.

In normal operating mode (online mode), a beacon as shown in FIG. 8 is used. The configuration can be uniquely identified by the 2-tuple {gateway ID, CSN}. If gateway ID or CSN do not match the values currently stored in the sensor node, the sensor node may not transmit any data according to its configuration. It must wait until gateway ID and CSN from the beacon match its currently stored values, the gateway switches to configuration mode and communicates a new configuration to it, or if management timeslots are available in the superframe, the sensor node requests for itself “in person” the current configuration from the gateway.

Upon receiving a beacon, the following algorithm is executed. Here “B_<field>” means the corresponding field from the beacon, and “SN_<field>_i” the corresponding attribute from the sensor node having the index i.

| | |
|---|---|
| 1. | valid_configuration := false |
| 2. | If B_gatewayID in SN_gatewayID_0. .k{ |
| 2.1. | i := j with B_gatewayID == SN_gatewayID_j |
| 2.2. | If B_CSN = SN_CSN_i{ |
| 2.2.1. | Use SN_configuration_i |
| 2.2.2. | valid_configuration := true |
| | } |
| | } |
| 3. | If not valid_configuration{ |
| 3.1. | Do not transmit data |
| 3.2. | Event notification to higher layer or management |
| | module or start of mechanisms to acquire a valid |
| | configuration (see above) |
| | } |
| 4. | END |

In order to shorten the processing time of a beacon, gateway ID and CSN from the beacon can first be compared with the corresponding attributes of the configuration last use (second algorithm). In this way, the entire list does not always have to be searched though. This can be implemented by a pointer to the relevant entry in the list of configurations or by a special data structure which contains the configuration last used and if required copies this in. The above algorithm then changes as follows:

| | |
|---|---|
| 1. | valid_configuration := false |
| 2. | If (B_gatewayID == SN_gatewayID_current) { |
| 2.1. | If (B_CSN == SN_CSN_current) { |
| 2.1.1. | Use SN_configuration_current |
| 2.1.2. | valid_configuration := true |
| | } |
| 2.2 | continue with 4. |
| | } |
| 3. | If B_gatewayID in SN_gatewayID_0. .k{ |
| 3.1. | i := j with B_gatewayID == SN_gatewayID_j |
| 3.2. | If B_CSN = SN_CSN_i{ |
| 3.2.1. | |
| | SN_configuration_current:=SN_configuration_i |
| 3.2.2. | Use SN_configuration_current |
| 3.2.3. | valid_configuration := true |
| | } |
| | } |
| 4. | If not valid_configuration{ |
| 4.1. | Do not transmit data |
| 4.2. | Event notification to higher layer or management |
| | module or start of mechanism to acquire a valid |
| | configuration (see above) |
| | } |
| 5. | END |

The method of the invention principally comprises an extended beacon format, an extended data structure for storing the current configuration in the sensor node, and rules as to how the new information in the beacon frame should be used.

### Extended Beacon Format

The transmission of the configuration of the management timeslots (length of the two management timeslots), which is determined from the two pieces of information transmitted, i.e., length of a base timeslot and number of base timeslots used per management timeslot, thus provides the sensor nodes with a range for which, after receiving the beacon, they know the configuration parameters and can therefore transmit control information arranged there. This is particularly important for new sensor nodes which have not yet been configured, for operating in discovery and in configuration mode and for sensor nodes which no longer have the current configuration and specifically want to request the current configuration for themselves from the gateway. The management timeslots with configuration transmitted in the beacon also support the use of HMI devices (HMI—human machine interface), such as portable panels, PDAs or notebooks which only occasionally have to be integrated in the star network for control and monitoring tasks.

Transmission of the gateway ID allows the unique assignment of a beacon to a gateway and thus to a star network. This makes it possible to distinguish different star networks. This enables the efficient and flexible roaming of sensor nodes.

Transmission of the configuration sequence number (CSN) for the current configuration makes it possible, together with the gateway ID, to recognize changes in the configuration of a star network even if the sensor node has not received all the beacons, i.e., may have missed a configuration cycle. This capacity to recognize an altered configuration supports roaming, as a sensor node is normally located for a longer period of time at other gateways. It also enables energy-saving by switching off the radio interface for a longer period. If a sensor node has no data to transmit, it can “go to sleep”. While it can wake up for each of the beacons and then receive these and then go to sleep again until the next beacon. Due to the CSN, however, it no longer needs to receive even this. By comparing the gateway ID and CSN, the sensor can determine whether it is still at the right gateway and whether it still has the current configuration. In this way, the sensor can determine whether it can send data without problems.

Despite the new additional information, the beacon in the preferred exemplary embodiment shown in FIG. 8 is still sufficiently compact. The beacon supports 88 sensor nodes in the star network without needing the long interframe spacing of 40 symbols. This number of sensor nodes is adequate for most applications envisaged. 88 sensor nodes mean 11 octets in the group acknowledgement, thus there would be 18 octets in the MAC packet, the maximum value for the short interframe spacing.

### Extended Data Structure on the Sensor Node

The extended data structure on the sensor node permits the storage of configurations for multiple gateways, an important prerequisite for roaming, as well as the newly introduced attributes of a configuration (gateway ID and CSN).

### Rules

The rules for using the new information from the beacon enable the efficient support of roaming and energy-saving.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

Further features and advantages of the invention will emerge from an exemplary embodiment that will be explained below with the aid of the drawings, in which:

FIG. 1 shows a beacon frame format defined in document [3];

FIG. 2 shows a superframe structure with GTSs defined in section 5.5.1 of document [2];

FIG. 3 shows a beacon frame format defined in section 7.2.2.1 of document [2];

FIG. 4 shows a format of the frame control field defined in section 7.2.1.1 of document [2];

FIG. 5 shows a format of the shortened beacon frame defined in section 4.2 of document [1];

FIG. 6 shows a format of the shortened frame control field defined in section 4.1.1 of document [1];

FIG. 7 shows a beacon payload in online mode defined in section 4.2.1 of document [1];

FIG. 8 shows an embodiment of a packet structure of a beacon according to the invention;

FIG. 9 shows a sensor node according to the invention with a list of configurations;

FIG. 10 shows a schematic representation of the transmission modes defined in document [1];

FIG. 11 shows a schematic representation of an exemplary wireless communication network for a production automation system;

FIG. 12 shows a tabular representation of superframe configurations on a network node of the communication network according to FIG. 11 at various times;

FIG. 13 shows a beacon of a network node of a communication network according to FIG. 11 at a particular time; and

FIG. 14 is a flow chart of the method in accordance with an embodiment of the invention.

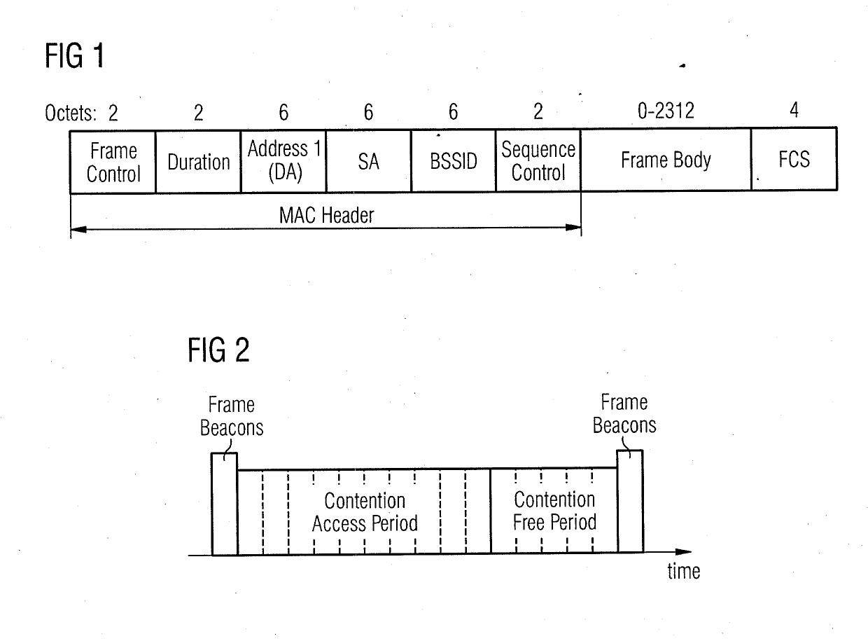

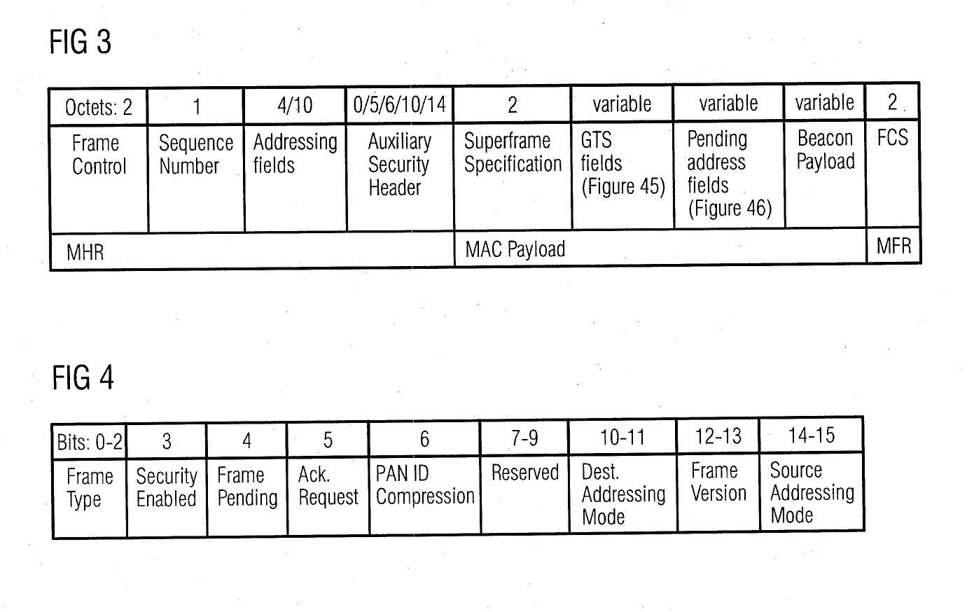

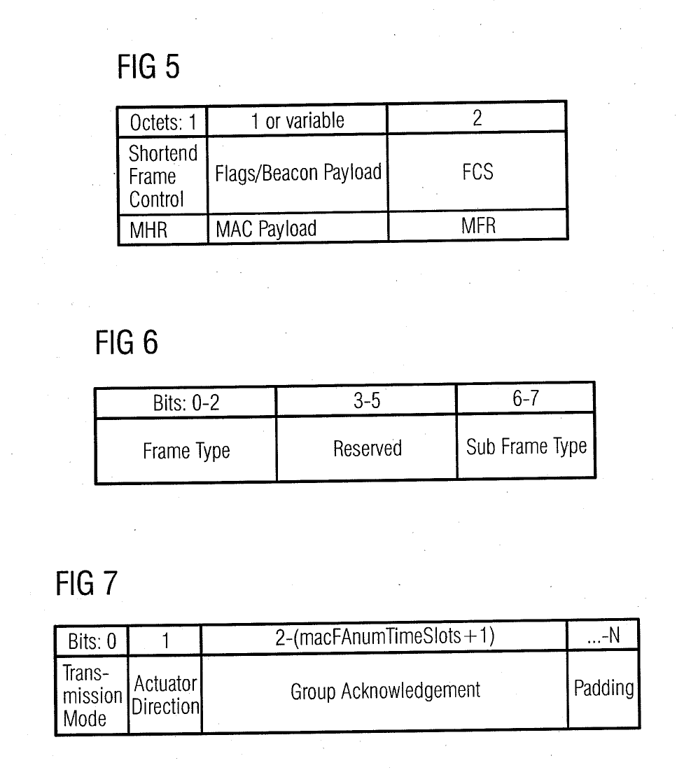

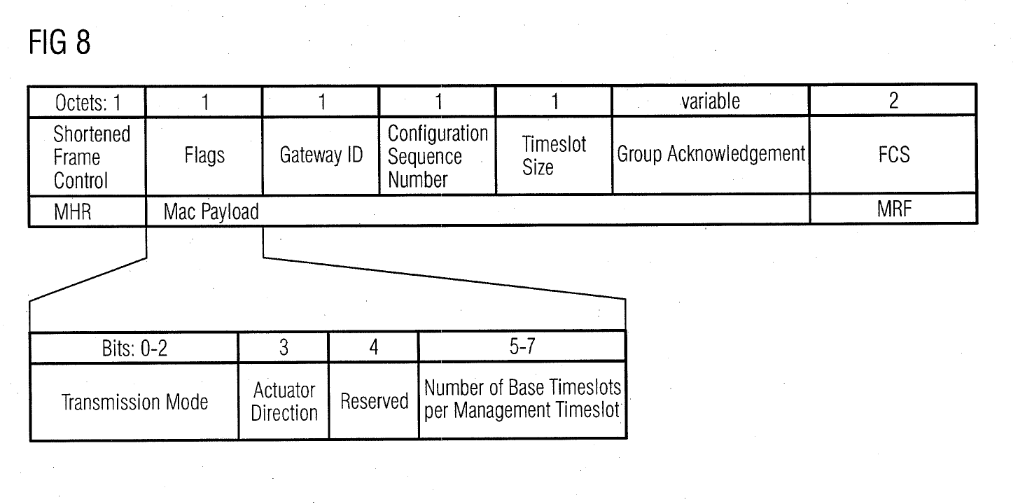

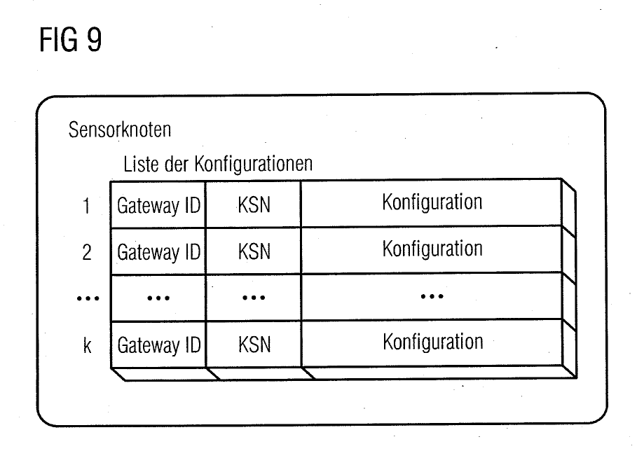

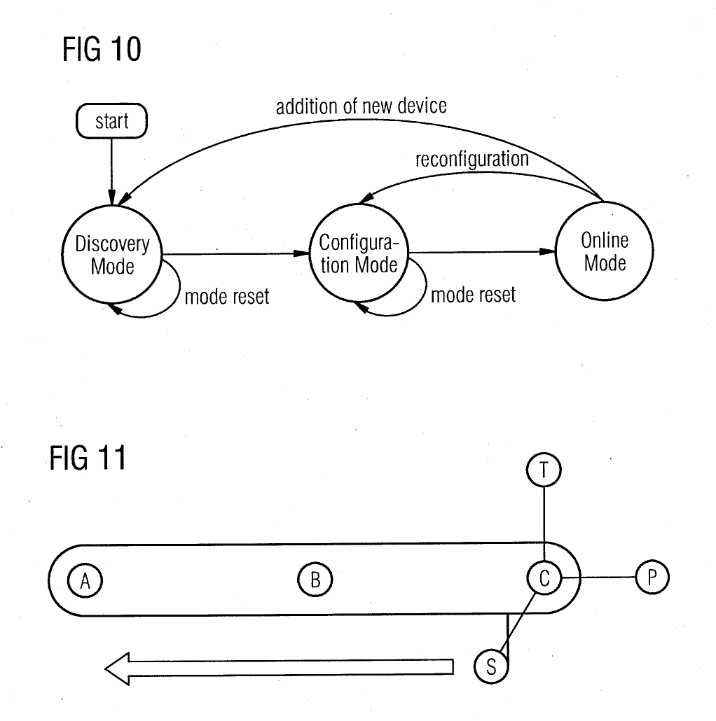

### DETAILED DESCRIPTION OF THE PREFERRED EMBODIMENTS

For the exemplary embodiment, the simplified wireless communication network shown in FIG. 11 for the production automation system is examined. Nodes A, B and C are three gateways. Nodes S, T and P are sensor nodes. The sensor node S moves on a conveyor belt around the three gateways A, B and C. A sensor node can at most be in the radio range of two adjacent gateways simultaneously. The radio ranges of the gateways are traversed in the recurring sequence C-B-A-B. Sensor nodes T and P are stationary and can communicate via radio with gateway C. Sensor node P is battery-operated and switches itself off for extended periods to save power. The radio connections are indicated by thin dotted lines.

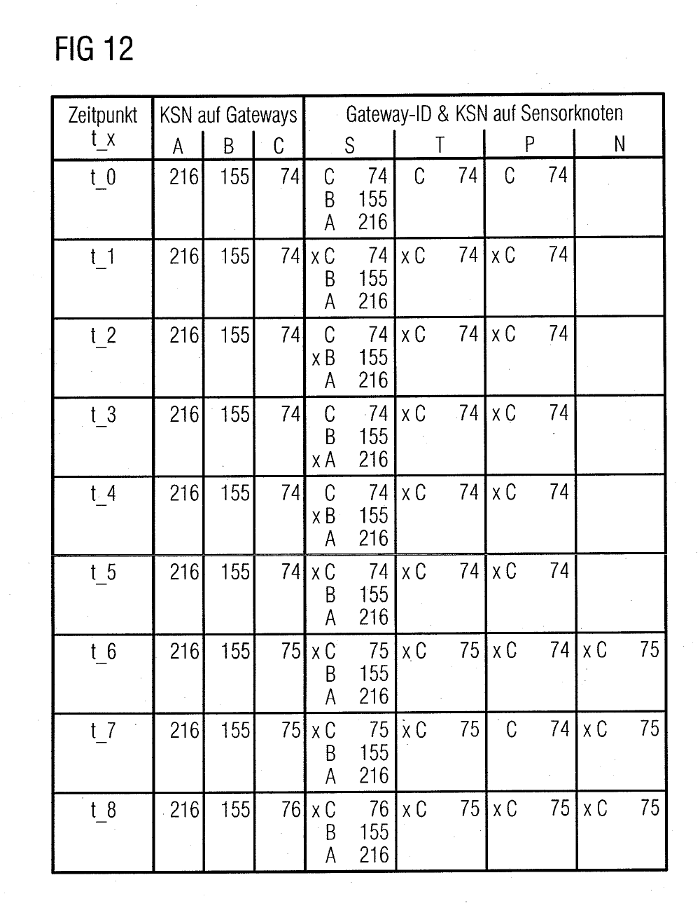

The corresponding superframe configurations of the gateways and sensor nodes at the various times used in the exemplary embodiment are indicated in tabular form in FIG. 12. It is not the actual superframe configuration that is presented but only the new attributes in accordance with the invention: the gateway ID and the configuration sequence number (CSN). For the exemplary embodiment, the name of the gateway is used for the gateway ID (A, B or C) for the sake of simplicity. The configuration used as a particular time (current configuration) is marked by a x in front of the corresponding gateway ID.

During the configuration at time t₀, which is not examined in detail here, the sensor nodes receive the corresponding superframe configurations communicated to them. Determination of the current configuration is not yet necessary at this point in time t₀, as it is only during operation that it is necessary to know the configuration currently being used.

The production automation network now goes into operation, and the sensor nodes are located at time t1 at the positions shown in FIG. 11. Sensor nodes S, T and P, provided P is not in sleep mode, now receive the beacons of gateway C with gateway ID (“C”) and CSN (“74”). In accordance with the second algorithm, the sensor nodes compare these two values in the second step of the algorithm with the corresponding values of their current configuration. All the sensor nodes establish a match (C=C in step 2 and 74=74 in step 2.1) and use their previous current configuration (step 2.1.1).

Sensor node S now moves on the conveyor belt through the radio ranges of the gateways A, B and C. At time t₂, sensor node S switches from gateway C to gateway B. Sensor node S now receives the first beacon from gateway B. In accordance with the second algorithm, S compares the gateway ID (“B”) contained in the beacon with its current configuration (step 2). There is not a match, as the gateway IDs are not the same (B≠C). Therefore, the process continues with step 3 in which the list of configurations is gone through and it is checked whether there is a corresponding configuration for the values from the beacon. That is the case here (B=B and 155=155). Sensor node S now uses this configuration.

At time t₃, sensor node S switches from gateway B to gateway A. Sensor node S now receives the first beacon from gateway A. In accordance with the second algorithm, S compares the gateway ID (“A”) contained in the beacon with its current configuration (step 2). There is not a match, as the gateway IDs are not the same (A≠B). Therefore, the process continues with step 3 in which the list of configurations is processed sequentially and it is checked whether there is a corresponding configuration for the values from the beacon. That is the case here (A=A and 216=216). Sensor node S now uses this configuration.

Sensor node S switches at time t₄ from gateway A to gateway B, and at time t₅ from gateway B to gateway C. At both times, the same algorithmic steps proceed as already described for times t₂ and t₃. The circuit of the sensor node S is now complete, and it continues by switching again from gateway C to gateway B as at time t₂.

After a certain time of this normal operating mode, sensor P switches off its radio module for an extended period to save electricity. While sensor P is sleeping, a new sensor node N additionally comes into the network at time t₆. It is in the radio range of gateway C, which now communicates to the sensor nodes in its range (including sensor node S) a new configuration with CSN=75 that contains the new sensor node N. Sensor node P “sleeps through” this new configuration.

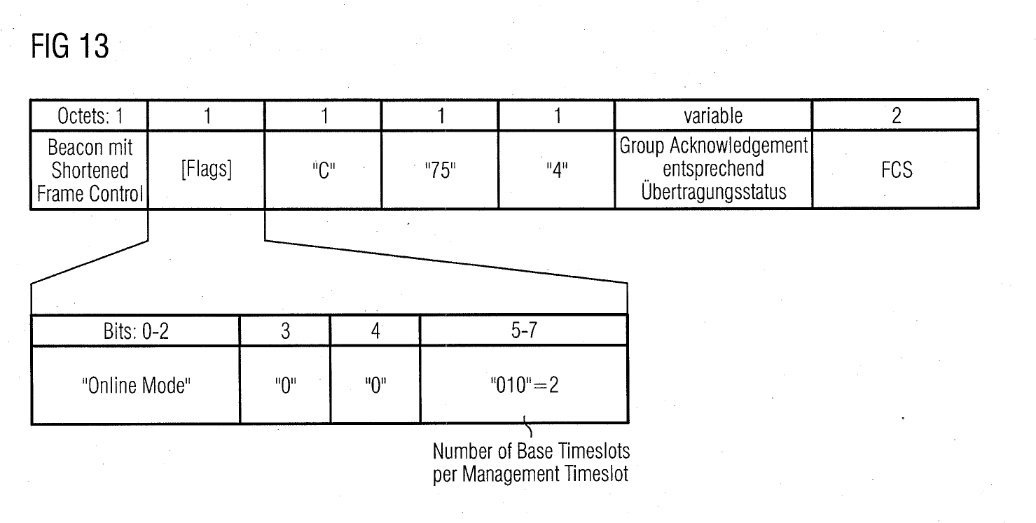

At time t7, sensor node P switches its radio module on again and receives the first beacon from gateway C (see FIG. 13). In accordance with the second algorithm, S compares the gateway ID (“C”) and CSN (“75”) contained in the beacon with its current configuration (steps 2 and 2.1). Though the gateway ID matches (C=C), the configuration sequence numbers are different (74≠75). The process must therefore continue with step 2.2 or step 4, sensor node P cannot transmit its data in this superframe. As can be seen from FIG. 13, management timeslots are contained in the superframe, as the field “Number of base timeslots per management timeslot” is greater than zero, in this case it contains the binary value 010 (=2). In this exemplary embodiment, sensor node P uses these management timeslots to inform gateway C about its missing configuration. Gateway C communicates the new configuration with the CSN=75 to sensor node P. This is shown at time t8. Node P can consequently participate in the communication again.

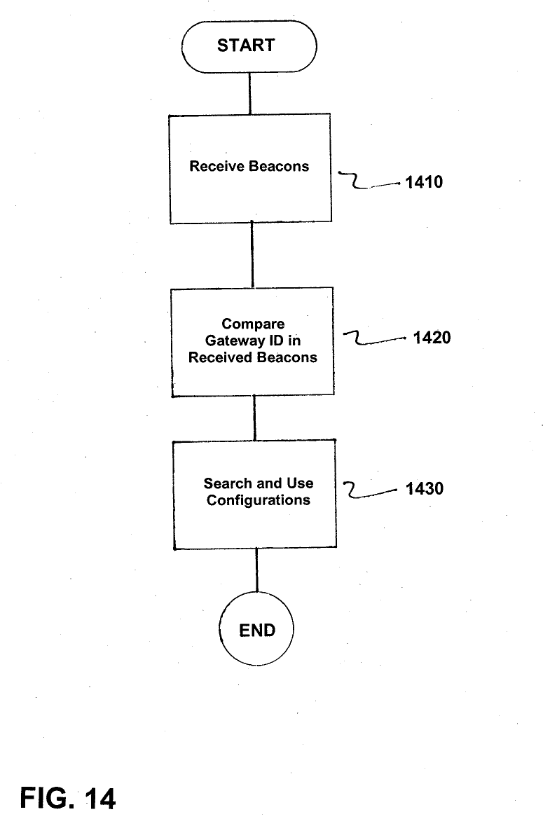

FIG. 14 is a flow chart of a method for operating a star network having a gateway and multiple sensor nodes. The method comprises receiving, by the sensor nodes, beacons from the gateway, as indicated in step 1410. Here, the beacons comprise a gateway ID and configuration sequence number.

The received gateway ID and configuration sequence number are compared with corresponding values of a current configuration of a respective sensor node, as indicted in step 1420.

If a sensor node establishes that a match has not occurred, configurations stored in the respective sensor node are then searched to ascertain whether there is an appropriate configuration for the gateway ID and the configuration sequence number and the appropriate configuration is used if there is an appropriate configuration for the gateway ID and the configuration sequence number, as indicated in step 1430.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-15. (canceled)

16. A gateway for a star network including at least one sensor node, the gateway transmitting a beacon including:
fields containing information on a length of a base timeslot and information on a number of base timeslots used per management timeslot;
wherein the management timeslots are used to transmit at least configurations for the star network.

17. The gateway as claimed in claim 16, wherein the beacon includes further fields containing a gateway ID comprising an identifier for the gateway of the star network and a configuration sequence number comprising an identifier for a current configuration of the star network.

18. The gateway as claimed in claim 17, wherein the gateway ID is one of:
derived from a Media Access Control (MAC) address of the gateway, or
a random number and predefined by a network management system.

19. A gateway including the beacon of claim 16, wherein the gateway includes a superframe configuration comprising the beacon.

20. The gateway as claimed in claim 19, wherein a management timeslot is available for each transmission direction and the management timeslots are arranged directly after the beacon.

21. The gateway as claimed in claim 19, wherein access to the management timeslots is always performed based on carrier sense multiple access (CSMA).

22. A sensor node in a star network, the sensor node having a data structure for storing a configuration of the star network, the data structure having attributes comprising a gateway ID of the configuration and a configuration sequence number of the configuration.

23. The sensor node as claimed in claim 22, wherein the data structure can store k≧1 configurations and is organized as a list or a field.

24. A star network comprising a gateway and multiple sensor nodes as claimed in claim 22.

25. A method for initializing a gateway in a star network comprising a gateway and multiple sensor nodes, the method comprising:
detecting a gateway ID; and
determining start values for the gateway ID and a configuration sequence number.

26. The method as claimed in claim 25, wherein a start value for the gateway ID comprises a random value or a final octet of a MAC address of the gateway.

27. The method as claimed in claim 25, wherein a start value for the gateway ID is stipulated by a network management system.

28. The method as claimed in claim 25, wherein a distributed algorithm is used for recognizing gateway ID duplicates or for assigning a duplicate-free gateway ID.

29. A method for operating a star network having a gateway and multiple sensor nodes, the method comprising:
receiving, by the sensor nodes, beacons from the gateway, the beacons comprising a gateway ID and configuration sequence number;
comparing the received gateway ID and configuration sequence number with corresponding values of a current configuration of a respective sensor node; and
if a sensor node establishes that a match has not occurred, searching configurations stored in the respective sensor node to ascertain whether there is an appropriate configuration for the gateway ID and the configuration sequence number and using the appropriate configuration if there is an appropriate configuration for the gateway ID and the configuration sequence number.

30. The method as claimed in claim 29, further comprising:
providing, by a management timeslot, a notification to the gateway of a missing configuration if no match of the received gateway ID and configuration sequence number with the corresponding values of the current configuration of the sensor node is determined and no configuration corresponding to the gateway ID and the configuration sequence number is stored in the sensor node.
